(19) United States
(12) Patent Application Publication
(10) Pub. No.: US 2025/0148806 A1
(43) Pub. Date: May 8, 2025

(54) METHOD AND PROCESSOR FOR CLASSIFYING POINTS ON A POLYGON BOUNDARY

(71) Applicant: Y.E. Hub Armenia LLC, Yerevan (AM)

(72) Inventor: Viktor YURCHENKO, Barnaul (RU)

(21) Appl. No.: 18/934,672

(22) Filed: Nov. 1, 2024

(30) Foreign Application Priority Data
Nov. 2, 2023 (RU) 2023128466

(51) Int. Cl. G06V 20/56; G06V 10/26; G06V 10/774; G06V 10/82

(52) U.S. Cl. CPC G06V 20/588; G06V 10/26; G06V 10/774; G06V 10/82

(57) ABSTRACT

Methods and systems of classifying points on a polygon boundary. The method includes acquiring image data about a training region having a training object, generating a segmentation map based on the image data including a plurality of points and defining a training polygon boundary. The plurality of points are associated with a respective feature vector generated by the segmentation model. The method includes acquiring a ground-truth polygon boundary, determining a displacement indicative of a label for the given boundary point between the position and a closest edge from the sequence of edges, and training a second model. A training iteration includes using the position of the given boundary point, a feature vector associated with the boundary point, and a set of feature vectors of neighboring points for generating a predicted score and adjusting the second model based on a comparison between the predicted score and the label.

### CROSS-REFERENCE

The present application claims priority to Russian Patent Application No. 2023128466, entitled “Method and Processor for Classifying Points on a Polygon Boundary”, filed Nov. 2, 2023, the entirety of which is incorporated herein by reference.

### TECHNICAL FIELD

The present technology relates generally to image processing and, in particular, to methods and processors for classifying points on a polygon boundary.

### BACKGROUND

Several computer-based navigation systems that are configured for aiding navigation and/or control of vehicles have been proposed and implemented in the prior art. These systems range from more basic map-aided localization-based solutions—i.e. use of a computer system to assist a driver in navigating a route from a starting point to a destination point; to more complex ones such as computer-assisted and/or driver-autonomous driving systems.

Some of these systems are implemented as what is commonly known as a “cruise control” system. Within these systems, the computer system located on the vehicles maintains a user-set speed of the vehicle. Some of the cruise control systems implement an “intelligent distance control” system, whereby the user can set up a distance to a potential car in front (such as, select a value expressed in a number of vehicles) and the computer system adjusts the speed of the vehicle at least in part based on the vehicle approaching the potential vehicle in front within the pre-defined distance. Some of the cruise control systems are further equipped with collision control systems, which systems, upon detection of the vehicle (or other obstacles) in front of the moving vehicle, slow down or stop the vehicle.

Some of the more advanced systems provide for a fully autonomous driving of the vehicle without direct control from the operator (i.e. the driver). These autonomously driven vehicles include systems that can cause the vehicle to accelerate, brake, stop, change lane and self-park.

Autonomous vehicles can use map data to process information for navigation and control in addition to or instead of relying on sensor data. However conventional maps have several drawbacks that make them difficult to use for an autonomous vehicle, such as self-driving cars and delivery robots. For example maps do not provide the level of accuracy required for safe navigation (e.g., 10 cm or less). GPS systems provide accuracies of approximately 3-5 meters, but have large error conditions resulting in an accuracy of over 100 meters. This makes it challenging to accurately determine the location of the vehicle. Conventional techniques of maintaining digital maps and identifying objects on the maps are unable to provide data that is sufficiently accurate and up-to-date for safe navigation and control of autonomous vehicles.

US Patent application no. 2018/0188059 discloses a system that generates lane lines designating lanes of roads based on, for example, mapping of camera image pixels with high probability of being on lane lines.

### SUMMARY

Therefore, there is a need for systems and methods which avoid, reduce or overcome the limitations of the prior art.

In the context of the present technology, a segmentation model is employed for segmenting image data about regions of a map for identifying “objects” and generating boundaries for these objects in the corresponding map regions. It is contemplated that these objects may include, road segments accessible by road vehicles (e.g., cars, trucks, buses, and motorcycles), sidewalk segments accessible by pedestrians and relatively small robotic vehicles (e.g., delivery rovers), path segments accessible by pedestrians, road vehicles, as well as relatively small robotic vehicles, and the like.

The segmentation model may be employed, during its in-use phase, on map regions that have not been assessed by human assessors. For example, a cartographer may be tasked with tracing boundaries for one or more classes of objects on a map. However, gathering such human-assessed data is costly in terms of time and monetary considerations. Since gathering “ground-truth” boundaries of objects on a very large map is not a practical solution, developers of the present technology have devised a system where ground-truth boundary information about objects is used in human-assessed regions of the map, and where outputs of the segmentation model can be used for regions of the map that have not been so-assessed.

Developers of the present technology have realized that, although using the segmentation model in non-assessed regions is beneficial, the segmentation model can still suffer from poor prediction quality in some of these non-assessed regions. To that end, the developers have devised methods and systems that employ a second model for providing an indication of confidence in the boundary information generated by the segmentation model.

Broadly speaking, the second model may be trained to predict a “confidence score” for one or more points along a boundary generated by the segmentation model, and which confidence scores are indicative of whether the corresponding points have been correctly positioned on the map, or otherwise erroneously positioned on the map. In some embodiments, it can be said that the confidence scores are indicative of a likelihood that corresponding points have been correctly positioned on the map. In further embodiments, it can be said that the confidence scores are indicative of a level of confidence in that the corresponding points have been correctly positioned on the map.

Assessed regions of the map may be used for training the second model based on ground-truth data from human assessors and segmentation data from the segmentation model. When the prediction model, during its in-use phase, determines that one or more points from the boundary generated by the segmentation model for a non-assessed region are likely to be erroneously positioned, this non-assessed region can be marked for human assessment. In other words, the segmentation model may be used for generating boundary polygons in some non-assessed regions without further human input, while in other non-assessed regions the output of the second model may indicate that human-assessors are to be tasked with providing ground-truth boundaries instead of relying solely on the outputs of the segmentation model.

In a first broad aspect of the present technology, there is provided a method of classifying points on a polygon boundary. The method is executed by a processor. The method comprises acquiring, by the processor, image data about a training region having a training object. The method comprises generating, by the processor using a segmentation model, a segmentation map based on the image data. The segmentation map includes a plurality of points and defining a training polygon boundary. The plurality of points is associated with a respective feature vector generated by the segmentation model. The training polygon boundary identifies the training object in the training region. The training polygon boundary includes a sequence of boundary points. A position of a given boundary point in the sequence is defined as a change in position from a position of a preceding boundary point in the sequence. The method comprises acquiring, by the processor, a ground-truth polygon boundary identifying the training object on the segmentation map. The ground-truth polygon boundary includes a sequence of boundary edges identified by a human assessor. The method comprises for the given boundary point in the sequence, determining a displacement between the position and a closest edge from the sequence of edges. The displacement is indicative of a label for the given boundary point. The method comprises training, by the processor, a second model for predicting a confidence score for an in-use boundary point of an in-use polygon boundary. The training includes, during a given training iteration, using, by the second model, the position of the given boundary point, the feature vector associated with the boundary point, and a set of feature vectors of neighboring points on the segmentation map representative of a context of the given boundary point, for generating a predicted score. The training includes, during a given training iteration, adjusting the second model based on a comparison between the predicted score and the label.

In some embodiments of the method, the method further comprises acquiring, by the processor, in-use image data about an in-use region having an in-use object. The in-use object not having been assessed by the human assessor for generating a ground-truth polygon boundary identifying the in-use object. The method further comprises generating, by the processor using the segmentation model, an in-use segmentation map defining the in-use polygon boundary, the in-use polygon boundary including a sequence of in-use boundary points. The method further comprises generating, by the processor using the second model, the confidence score for the in-use boundary point from the sequence of in-use boundary points. The method further comprises in response to the confidence score being indicative of a low confidence, automatically identifying at least a portion of the in-use region for human assessment. The method further comprises acquiring, by the processor, the ground-truth polygon boundary of the in-use object from the human assessor.

In some embodiments of the method, the training object is one of a road segment, and a sidewalk segment.

In some embodiments of the method, the image data comprises a birds-eye view representation of the training region.

In some embodiments of the method, the image data comprises a 2D image of the training region, the 2D image being generated from a 3D point cloud representative of the training region.

In some embodiments of the method, the image data comprises one or more raster images.

In some embodiments of the method, the segmentation model is a fully convolutional neural network.

In some embodiments of the method, the second model is a classification model, and wherein the label is indicative of a first class if the displacement is below a pre-determined threshold and is indicative of a second class if the displacement if above the pre-determined threshold, the first class being a high confidence class and the second class being a low confidence class.

In some embodiments of the method, the second model has two heads, a first head being trained based on a first label indicative of a given displacement to the closest edge, and a second head being trained on a second label indicative of whether the displacement is below or above a pre-determined threshold.

In some embodiments of the method, the in-use polygon boundary is stored in association with the in-use region, and the in-use polygon boundary is transmitted to a second processor associated with a vehicle for navigating the vehicle in the in-use region.

In some embodiments of the method, the vehicle is a Self-Driving Car (SDC) operating on road segments.

In some embodiments of the method, the vehicle is a delivery robot operating on sidewalk segments.

In a second broad aspect of the present technology, there is provided a processor for classifying points on a polygon boundary. The processor is configured to acquire image data about a training region having a training object. The processor is configured to generate, using a segmentation model, a segmentation map based on the image data. The segmentation map includes a plurality of points and defining a training polygon boundary, the plurality of points being associated with a respective feature vector generated by the segmentation model. The training polygon boundary identifies the training object in the training region, the training polygon boundary including a sequence of boundary points, a position of a given boundary point in the sequence being defined as a change in position from a position of a preceding boundary point in the sequence. The processor is configured to acquire a ground-truth polygon boundary identifying the training object on the segmentation map, the ground-truth polygon boundary including a sequence of boundary edges identified by a human assessor. The processor is configured to, for the given boundary point in the sequence, determine a displacement between the position and a closest edge from the sequence of edges, the displacement being indicative of a label for the given boundary point. The processor is configured to train a second model for predicting a confidence score for an in-use boundary point of an in-use polygon boundary. The training includes, during a given training iteration, use, by the second model, the position of the given boundary point, the feature vector associated with the boundary point, and a set of feature vectors of neighboring points on the segmentation map representative of a context of the given boundary point, for generating a predicted score. The training includes, during a given training iteration, adjust the second model based on a comparison between the predicted score and the label.

In some embodiments of the processor, the processor is further configured to acquire in-use image data about an in-use region having an in-use object, the in-use object not having been assessed by the human assessor for generating a ground-truth polygon boundary identifying the in-use object. The processor is further configured to generate, using the segmentation model, an in-use segmentation map defining the in-use polygon boundary, the in-use polygon boundary including a sequence of in-use boundary points. The processor is further configured to generate, using the second model, the confidence score for the in-use boundary point from the sequence of in-use boundary points. The processor is further configured to, in response to the confidence score being indicative of a low confidence, automatically identify at least a portion of the in-use region for human assessment. The processor is further configured to acquire the ground-truth polygon boundary of the in-use object from the human assessor.

In some embodiments of the processor, the training object is one of a road segment, and a sidewalk segment.

In some embodiments of the processor, the image data comprises a birds-eye view representation of the training region.

In some embodiments of the processor, the image data comprises a 2D image of the training region, the 2D image being generated from a 3D point cloud representative of the training region.

In some embodiments of the processor, the image data comprises one or more raster images.

In some embodiments of the processor, the segmentation model is a fully convolutional neural network.

In some embodiments of the processor, the second model is a classification model, and wherein the label is indicative of a first class if the displacement is below a pre-determined threshold and is indicative of a second class if the displacement if above the pre-determined threshold, the first class being a high confidence class and the second class being a low confidence class.

In some embodiments of the processor, the second model has two heads, a first head being trained based on a first label indicative of a given displacement to the closest edge, and a second head being trained on a second label indicative of whether the displacement is below or above a pre-determined threshold.

In some embodiments of the processor, the in-use polygon boundary is stored in association with the in-use region, and wherein the in-use polygon boundary is transmitted to a second processor associated with a vehicle for navigating the vehicle in the in-use region.

In some embodiments of the processor, the vehicle is a Self-Driving Car (SDC) operating on road segments.

In some embodiments of the processor, the vehicle is a delivery robot operating on sidewalk segments.

In the context of the present specification, the term “light source” broadly refers to any device configured to emit radiation such as a radiation signal in the form of a beam, for example, without limitation, a light beam including radiation of one or more respective wavelengths within the electromagnetic spectrum. In one example, the light source can be a “laser source”. Thus, the light source could include a laser such as a solid-state laser, laser diode, a high power laser, or an alternative light source such as, a light emitting diode (LED)-based light source. Some (non-limiting) examples of the laser source include: a Fabry-Perot laser diode, a quantum well laser, a distributed Bragg reflector (DBR) laser, a distributed feedback (DFB) laser, a fiber-laser, or a vertical-cavity surface-emitting laser (VCSEL). In addition, the laser source may emit light beams in differing formats, such as light pulses, continuous wave (CW), quasi-CW, and so on. In some non-limiting examples, the laser source may include a laser diode configured to emit light at a wavelength between about 650 nm and 1150 nm. Alternatively, the light source may include a laser diode configured to emit light beams at a wavelength between about 800 nm and about 1000 nm, between about 850 nm and about 950 nm, between about 1300 nm and about 1600 nm, or in between any other suitable range. Unless indicated otherwise, the term “about” with regard to a numeric value is defined as a variance of up to 10% with respect to the stated value.

In the context of the present specification, an “output beam” may also be referred to as a radiation beam, such as a light beam, that is generated by the radiation source and is directed downrange towards a region of interest. The output beam may have one or more parameters such as: beam duration, beam angular dispersion, wavelength, instantaneous power, photon density at different distances from light source, average power, beam power intensity, beam width, beam repetition rate, beam sequence, pulse duty cycle, wavelength, or phase etc. The output beam may be unpolarized or randomly polarized, may have no specific or fixed polarization (e.g., the polarization may vary with time), or may have a particular polarization (e.g., linear polarization, elliptical polarization, or circular polarization).

In the context of the present specification, an “input beam” is radiation or light entering the system, generally after having been reflected from one or more objects in the ROI. The “input beam” may also be referred to as a radiation beam or light beam. By reflected is meant that at least a portion of the output beam incident on one or more objects in the ROI, bounces off the one or more objects. The input beam may have one or more parameters such as: time-of-flight (i.e., time from emission until detection), instantaneous power (e.g., power signature), average power across entire return pulse, and photon distribution/signal over return pulse period etc. Depending on the particular usage, some radiation or light collected in the input beam could be from sources other than a reflected output beam. For instance, at least some portion of the input beam could include light-noise from the surrounding environment (including scattered sunlight) or other light sources exterior to the present system.

In the context of the present specification, the term “surroundings” or “environment” of a given vehicle refers to an area or a volume around the given vehicle including a portion of a current environment thereof accessible for scanning using one or more sensors mounted on the given vehicle, for example, for generating a 3D map of the such surroundings or detecting objects therein.

In the context of the present specification, a “Region of Interest” may broadly include a portion of the observable environment of a LIDAR system in which the one or more objects may be detected. It is noted that the region of interest of the LIDAR system may be affected by various conditions such as but not limited to: an orientation of the LIDAR system (e.g. direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The ROI of LIDAR system may be defined, for example, by a plane angle or a solid angle. In one example, the ROI may also be defined within a certain distance range (e.g. up to 200 m or so).

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system configurable for implementing certain non-limiting embodiments of the present technology.

FIG. 2 depicts a schematic diagram of a networked computing environment being suitable for use with certain non-limiting embodiments of the present technology.

FIG. 3 depicts a schematic diagram of an example LIDAR system implemented in accordance with certain non-limiting embodiments of the present technology.

FIG. 4 depicts data stored in a storage device of the networked computing environment of FIG. 2.

FIG. 5 is an illustration of a segmentation map generated by the server of FIG. 2 and which includes a boundary polygon, in accordance with certain non-limiting embodiments of the present technology.

FIG. 6 depicts a process of generating a segmentation map with a training boundary polygon and a ground-truth boundary polygon stored in the storage device of FIG. 4, in accordance with certain non-limiting embodiments of the present technology.

FIG. 7 depicts displacements between boundary points from the training boundary polygon and an edge of the ground-truth boundary polygon of FIG. 6, in accordance with certain non-limiting embodiments of the present technology.

FIG. 8 depicts a training process of a second model based on the training boundary polygon and the ground-truth boundary polygon of FIG. 6, in accordance with certain non-limiting embodiments of the present technology.

FIG. 9 depicts an in-use process of the second model of FIG. 8, in accordance with certain non-limiting embodiments of the present technology.

FIG. 10 is a schematic flowchart of a method executable in accordance with certain non-limiting embodiments of the present technology.

FIG. 11 is a schematic diagram of a machine learning architecture used for implementing the second model of FIG. 8, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

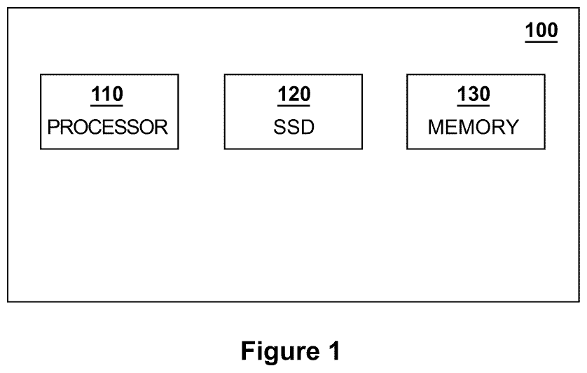

Referring initially to FIG. 1, there is depicted a schematic diagram of a computer system 100 suitable for use with some implementations of the present technology. The computer system 100 includes various hardware components including one or more single or multi-core processors collectively represented by a processor 110, a solid-state drive 120, and a memory 130, which may be a random-access memory or any other type of memory.

Communication between the various components of the computer system 100 may be enabled by one or more internal and/or external buses (not shown) (e.g. a PCI bus, universal serial bus, IEEE 1394 “Firewire” bus, SCSI bus, Serial-ATA bus, etc.), to which the various hardware components are electronically coupled. According to embodiments of the present technology, the solid-state drive 120 stores program instructions suitable for being loaded into the memory 130 and executed by the processor 110 for determining a presence of an object. For example, the program instructions may be part of a vehicle control application executable by the processor 110. It is noted that the computer system 100 may have additional and/or optional components (not depicted), such as network communication modules, localization modules, and the like.

### Networked Computing Environment

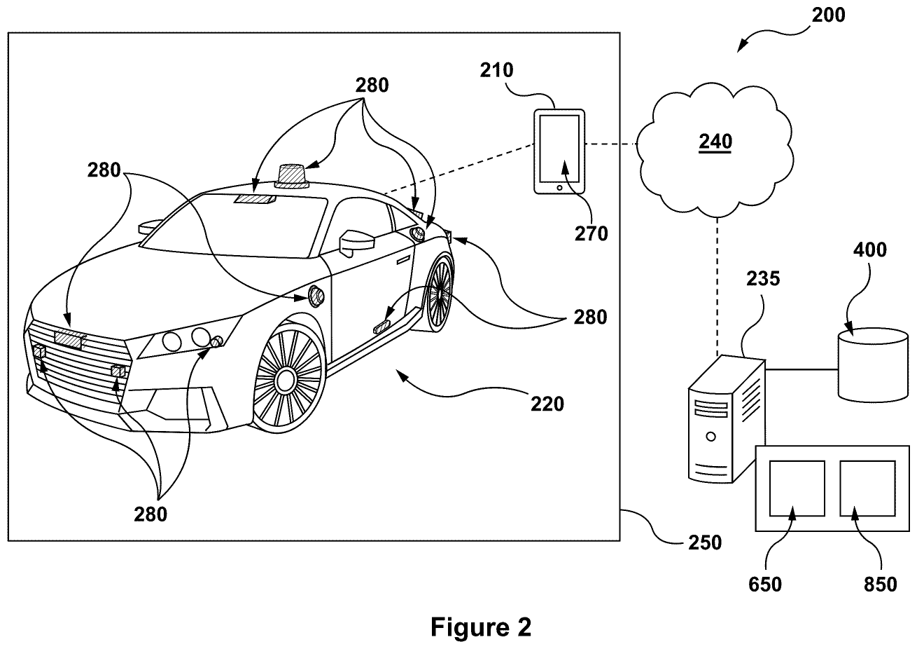

With reference to FIG. 2, there is depicted a networked computing environment 200 suitable for use with some non-limiting embodiments of the present technology. The networked computing environment 200 includes an electronic device 210 associated with a vehicle 220 and/or associated with a user (not depicted) who is associated with the vehicle 220 (such as an operator of the vehicle 220). The networked computing environment 200 also includes a server 235 in communication with the electronic device 210 via a communication network 240 (e.g. the Internet or the like, as will be described in greater detail herein below).

In some non-limiting embodiments of the present technology, the networked computing environment 200 could include a GPS satellite (not depicted) transmitting and/or receiving a GPS signal to/from the electronic device 210. It will be understood that the present technology is not limited to GPS and may employ a positioning technology other than GPS. It should be noted that the GPS satellite can be omitted altogether.

The vehicle 220, to which the electronic device 210 is associated, could be any transportation vehicle, for leisure or otherwise, such as a private or commercial car, truck, motorbike or the like. Although the vehicle 220 is depicted as being a land vehicle, this may not be the case in each and every non-limiting embodiment of the present technology. For example, in certain non-limiting embodiments of the present technology, the vehicle 220 may be a watercraft, such as a boat, or an aircraft, such as a flying drone.

The vehicle 220 may be user operated or a driver-less vehicle. In some non-limiting embodiments of the present technology, it is contemplated that the vehicle 220 could be implemented as a Self-Driving Car (SDC). It should be noted that specific parameters of the vehicle 220 are not limiting, these specific parameters including for example: vehicle manufacturer, vehicle model, vehicle year of manufacture, vehicle weight, vehicle dimensions, vehicle weight distribution, vehicle surface area, vehicle height, drive train type (e.g. 2× or 4×), tire type, brake system, fuel system, mileage, vehicle identification number, and engine size.

In other embodiments of the present technology, the vehicle 220 may be implemented as a delivery robot, or a “rover”, configured for delivery purposes. As opposed to SDCs that operate on a road, delivery robots typically operate on sidewalks or other portions of a geographical region where humans can walk. They are relatively small in size if compared to SDC and can navigate their environment for delivering items from sender to recipient.

According to the present technology, the implementation of the electronic device 210 is not particularly limited. For example, the electronic device 210 could be implemented as a vehicle engine control unit, a vehicle CPU, a vehicle navigation device (e.g. TomTom™, Garmin™), a tablet, a personal computer built into the vehicle 220, and the like. Thus, it should be noted that the electronic device 210 may or may not be permanently associated with the vehicle 220. Additionally or alternatively, the electronic device 210 could be implemented in a wireless communication device such as a mobile telephone (e.g. a smart-phone or a radio-phone). In certain embodiments, the electronic device 210 has a display 270.

The electronic device 210 could include some or all of the components of the computer system 100 depicted in FIG. 1, depending on the particular embodiment. In certain embodiments, the electronic device 210 is an on-board computer device and includes the processor 110, the solid-state drive 120 and the memory 130. In other words, the electronic device 210 includes hardware and/or software and/or firmware, or a combination thereof, for processing data as will be described in greater detail below.

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network 240 are for illustration purposes only. A communication link (not separately numbered) is provided between the electronic device 210 and the communication network 240, the implementation of which will depend, inter alia, on how the electronic device 210 is implemented. Merely as an example and not as a limitation, in those non-limiting embodiments of the present technology where the electronic device 210 is implemented as a wireless communication device such as a smartphone or a navigation device, the communication link can be implemented as a wireless communication link. Examples of wireless communication links may include, but are not limited to, a 3G communication network link, a 4G communication network link, and the like. The communication network 240 may also use a wireless connection with the server 235.

In some embodiments of the present technology, the server 235 is implemented as a computer server and could include some or all of the components of the computer system 100 of FIG. 1. In one non-limiting example, the server 235 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 235 is a single server. In alternative non-limiting embodiments of the present technology, the functionality of the server 235 may be distributed and may be implemented via multiple servers (not shown).

In some non-limiting embodiments of the present technology, the processor 110 of the electronic device 210 could be in communication with the server 235 to receive one or more updates. Such updates could include, but are not limited to, software updates, map updates, routes updates, weather updates, and the like. In some non-limiting embodiments of the present technology, the processor 110 can also be configured to transmit to the server 235 certain operational data, such as routes travelled, traffic data, performance data, and the like. Some or all such data transmitted between the vehicle 220 and the server 235 may be encrypted and/or anonymized.

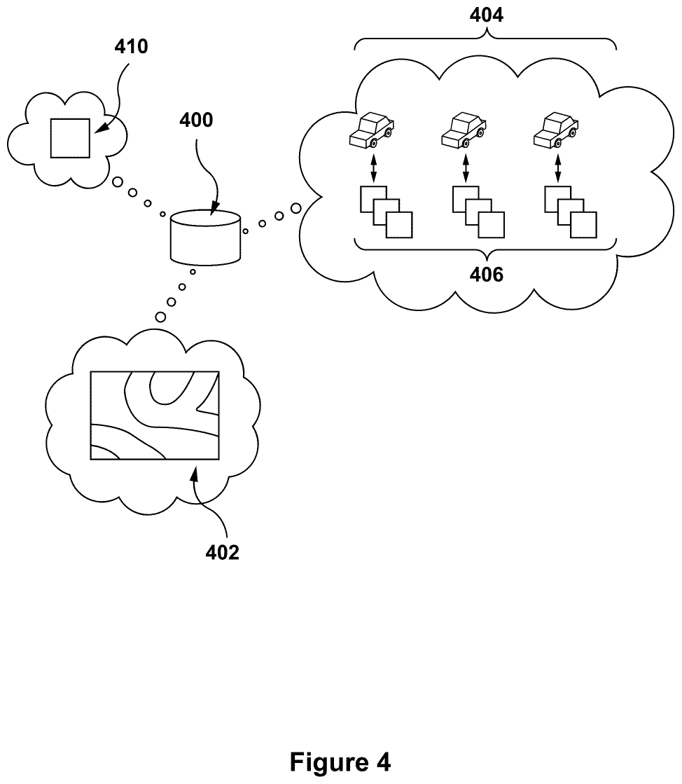

It should be noted that the server 235 may be communicatively coupled with a data storage device 400. The data storage device 400 may store a variety of data to be used by the server 235 and/or the electronic device 210. In some embodiments, the data storage device may host one or more databases. Broadly speaking, a database is an organized collection of data stored and accessed electronically. Small databases can be stored on a file system, while large databases are hosted on computer clusters or cloud storage. The design of databases spans over numerous techniques and practical considerations including data modeling, efficient data representation and storage, query languages, security and privacy of sensitive data, and distributed computing issues including supporting concurrent access and fault tolerance. At least some non-limiting examples of data stored in the data storage device 400 will be described herein further below with reference to FIG. 4.

In other embodiments of the present technology, the server 235 may be configured to execute one or more Machine Learned Algorithms (MLAs). Generally speaking, MLAs can learn from training samples and make predictions on new (unseen) data. The MLAs are usually used to first build a model based on training inputs of data in order to then make data-driven predictions or decisions expressed as outputs, rather than following static computer-readable instructions.

The MLAs are commonly used as estimation models, classification models, regression models, segmentation models and the like. It should be understood that different types of the MLAs having different structures or topologies may be used for various tasks. Data used during training can be stored in and accessed from the storage device 400 and can also be further processed for generating the training samples.

One particular type of MLAs includes Neural Networks (NNs). Generally speaking, a given NN consists of an interconnected group of artificial “neurons”, which process information using a connectionist approach to computation. NNs are used to model complex relationships between inputs and outputs (without actually knowing the relationships) or to find patterns in data. NNs are first conditioned in a training phase in which they are provided with a known set of “inputs” and information for adapting the NN to generate appropriate outputs (for a given situation that is being attempted to be modelled). During this training phase, the given NN adapts to the situation being learned and changes its structure such that the given NN will be able to provide reasonable predicted outputs for given inputs in a new situation (based on what was learned). Thus rather than trying to determine complex statistical arrangements or mathematical algorithms for a given situation; the given NN tries to provide an “intuitive” answer based on a “feeling” for a situation.

NNs are commonly used in many such situations where it is only important to know an output based on a given input, but exactly how that output is derived is of lesser importance or is unimportant. For example, NNs are commonly used to optimize the distribution of web-traffic between servers, automatic text translation into different languages, data processing, including filtering, clustering, vector embedding, and the like.

Furthermore, the implementation of a given MLA can be broadly categorized into two phases—a training phase and an in-use phase. Broadly speaking, a given MLA is first “built” (or trained) using training data and training targets. During a given training iteration, the MLA is inputted with a training input, and generates a respective prediction. The server 235 is then configured to, in a sense, “adjust” the MLA based on a comparison of the prediction against a respective training target for the training input. For example, the adjustment may be performed by the server 235 employing one or more machine learning techniques such as, but not limited to, a back-propagation technique. After a large number of training iterations, the MLA is thus “adjusted” in a manner that allows making predictions based on inputted data such that those predictions are close to the respective training targets.

As depicted in FIG. 2, the server 235 may execute a segmentation model 650 and a prediction model 850. The segmentation model 650 can be an MLA configured to perform image data segmentation. Broadly speaking, image segmentation is a process of segmenting a digital image into a plurality of image segments and can be used to locate objects and/or boundaries (lines, curves, etc.) in images. In some embodiments, it is contemplated that the segmentation model 650 may be configured to inter alia assign labels to respective pixels of an inputted image and such that pixels with a same label share some characteristic(s). In one example, pixels associated with a given label may be representative of a same object in the inputted image. It is also contemplated that a variety of algorithms could be applied onto the labelled pixels for determining a contour, or “boundary”, of the given object in the inputted image.

In some embodiments of the present technology, the segmentation model 650 may be implemented as a Convolutional Neural Network (CNN) trained for image segmentation applications. In one embodiment, the CNN may have a “U-Net” architecture. Broadly speaking, such a CNN consists of a contracting path and an expansive path, which gives it the u-shaped architecture. The contracting path is a CNN that consists of repeated application of convolutions, each followed by a rectified linear unit (ReLU) and a max pooling operation. During the contraction, the spatial information is reduced while feature information is increased. The expansive pathway combines the feature and spatial information through a sequence of up-convolutions and concatenations with high-resolution features from the contracting path. The U-Net architecture can have a large number of feature channels in the upsampling portion thereof, which allows the network to propagate context information to higher resolution layers.

In some embodiments, the segmentation model 650 may be implemented in a similar manner to the CNN disclosed in an article entitled “U-Net: Convolutional Networks for Biomedical Image Segmentation”, authored by Olaf Ronneberger et al., and published on May 18, 2015, the contents of which is incorporated herein by reference in its entirety.

As it will be described in greater details herein further below, the segmentation model 650 may be employed for segmenting image data about regions of a map for identifying “objects” and generating boundaries for these objects in the corresponding map regions. It is contemplated that these objects may include, road segments accessible by road vehicles (e.g., cars, trucks, buses, and motorcycles), sidewalk segments accessible by pedestrians and relatively small robotic vehicles (e.g., delivery rovers), path segments accessible by pedestrians, road vehicles, as well as relatively small robotic vehicles, and the like.

It should be noted that the segmentation model 650 may be employed, during its in-use phase, on map regions that have not been assessed by human assessors. For example, a cartographer may be tasked with tracing boundaries for one or more classes of objects on a map. However, gathering such human-assessed data is costly in terms of time and monetary considerations. Since gathering “ground-truth” boundaries of objects on a very large map is not a practical solution, developers of the present technology have devised a system where ground-truth boundary information about objects is used in human-assessed regions of the map, and where outputs of the segmentation model 650 can be used for regions of the map that have not been so-assessed.

Developers of the present technology have realized that, although using the segmentation model 650 in non-assessed regions is beneficial, the segmentation model 650 can still suffer from poor prediction quality in some of these non-assessed regions. To that end, the developers have devised methods and systems that employ the prediction model 850 for providing an indication of confidence in the boundary information generated by the segmentation model 650.

Broadly speaking, the prediction model 850 may be trained to predict a “confidence scores” for one or more points along a boundary generated by the segmentation model 650, and which confidence scores are indicative of whether the corresponding points have been correctly positioned on the map, or otherwise erroneously positioned on the map. In some embodiments, it can be said that the confidence scores are indicative of a likelihood that corresponding points have been correctly positioned on the map. In further embodiments, it can be said that the confidence scores are indicative of a level of confidence in that the corresponding points have been correctly positioned on the map. Assessed regions of the map may be used for training the prediction model 850 based on ground-truth data from human assessors and segmentation data from the segmentation model 650. How the prediction model 850 is trained will be discussed in greater details herein further below. Nevertheless, it should be noted that when the prediction model 850, during its in-use phase, determines that one or more points from the boundary generated by the segmentation model 650 for a non-assessed region are likely to be erroneously positioned, this non-assessed region can be marked for human assessment. In other words, the segmentation model 650 may be used for generating boundary polygons in some non-assessed regions without further human input, while in other non-assessed regions the output of the prediction model 850 may indicate that human-assessors are to be tasked with providing ground-truth boundaries instead of relying solely on the outputs of the segmentation model 650.

Returning to the description of FIG. 2, it should be noted that a variety of sensors and systems may be used by the electronic device 210 for gathering information about surroundings 250 of the vehicle 220. As seen, the vehicle 220 may be equipped with a plurality of sensor systems 280. It should be noted that different sensor systems from the plurality of sensor systems 280 may be used for gathering different types of data regarding the surroundings 250 of the vehicle 220.

In one example, the plurality of sensor systems 280 may include various optical systems including, inter alia, one or more camera-type sensor systems that are mounted to the vehicle 220 and communicatively coupled to the processor 110 of the electronic device 210. Broadly speaking, the one or more camera-type sensor systems may be configured to gather image data about various portions of the surroundings 250 of the vehicle 220. In some cases, the image data provided by the one or more camera-type sensor systems could be used by the electronic device 210 for performing object detection procedures. For example, the electronic device 210 could be configured to feed the image data provided by the one or more camera-type sensor systems to an Object Detection Neural Network (ODNN) that has been trained to localize and classify potential objects in the surroundings 250 of the vehicle 220.

In another example, the plurality of sensor systems 280 could include one or more radar-type sensor systems that are mounted to the vehicle 220 and communicatively coupled to the processor 110. Broadly speaking, the one or more radar-type sensor systems may be configured to make use of radio waves to gather data about various portions of the surroundings 250 of the vehicle 220. For example, the one or more radar-type sensor systems may be configured to gather radar data about potential objects in the surroundings 250 of the vehicle 220, such data potentially being representative of a distance of objects from the radar-type sensor system, orientation of objects, velocity and/or speed of objects, and the like.

It should be noted that the plurality of sensor systems 280 could include additional types of sensor systems to those non-exhaustively described above and without departing from the scope of the present technology.

In some embodiments of the present technology, the vehicle 220 may be implemented as a delivery rover. Delivery rovers, or autonomous delivery robots, are relatively small size vehicles that are used for delivery purposes. They can navigate on sidewalks, for example, and are adapted for traversing a variety of obstacles that are located on its route to destination. The benefits of autonomous delivery robots include a reduction in the need for large, potentially emission-heavy trucks to move in crowded cities and a reduction in the number of delivery drivers required to get the items users order online to them quickly.

### LIDAR System

According to the non-limiting embodiments of the present technology and as is illustrated in FIG. 2, the vehicle 220 is equipped with at least one Light Detection and Ranging (LIDAR) system, such as a LIDAR system 300, for gathering information about surroundings 250 of the vehicle 220. While only described herein in the context of being attached to the vehicle 220, it is also contemplated that the LIDAR system 300 could be a stand-alone operation or connected to another system.

Depending on the embodiment, the vehicle 220 could include more or fewer LIDAR systems 300 than illustrated. Depending on the particular embodiment, choice of inclusion of particular ones of the plurality of sensor systems 280 could depend on the particular embodiment of the LIDAR system 300. The LIDAR system 300 could be mounted, or retrofitted, to the vehicle 220 in a variety of locations and/or in a variety of configurations.

For example, depending on the implementation of the vehicle 220 and the LIDAR system 300, the LIDAR system 300 could be mounted on an interior, upper portion of a windshield of the vehicle 220. Nevertheless, as illustrated in FIG. 2, other locations for mounting the LIDAR system 300 are within the scope of the present disclosure, including on a back window, side windows, front hood, rooftop, front grill, front bumper or the side of the vehicle 220. In some cases, the LIDAR system 300 can even be mounted in a dedicated enclosure mounted on the top of the vehicle 220.

In some non-limiting embodiments, such as that of FIG. 2, a given one of the plurality of LIDAR systems 300 is mounted to the rooftop of the vehicle 220 in a rotatable configuration. For example, the LIDAR system 300 mounted to the vehicle 220 in a rotatable configuration could include at least some components that are rotatable 360 degrees about an axis of rotation of the given LIDAR system 300. When mounted in rotatable configurations, the given LIDAR system 300 could gather data about most of the portions of the surroundings 250 of the vehicle 220.

In some non-limiting embodiments of the present technology, such as that of FIG. 2, the LIDAR systems 300 is mounted to the side, or the front grill, for example, in a non-rotatable configuration. For example, the LIDAR system 300 mounted to the vehicle 220 in a non-rotatable configuration could include at least some components that are not rotatable 360 degrees and are configured to gather data about pre-determined portions of the surroundings 250 of the vehicle 220.

Irrespective of the specific location and/or the specific configuration of the LIDAR system 300, it is configured to capture data about the surroundings 250 of the vehicle 220 used, for example, for building a multi-dimensional map of objects in the surroundings 250 of the vehicle 220. Details relating to the configuration of the LIDAR systems 300 to capture the data about the surroundings 250 of the vehicle 220 will now be described.

It should be noted that although in the description provided herein the LIDAR system 300 is implemented as a Time of Flight LIDAR system—and as such, includes respective components suitable for such implementation thereof—other implementations of the LIDAR system 300 are also possible without departing from the scope of the present technology. For example, in certain non-limiting embodiments of the present technology, the LIDAR system 300 may also be implemented as a Frequency-Modulated Continuous Wave (FMCW) LIDAR system according to one or more implementation variants and based on respective components thereof as disclosed in a Russian Patent Application 2020117983 filed Jun. 1, 2020 and entitled “Lidar Detection Methods And Systems”, the content of which is hereby incorporated by reference in its entirety.

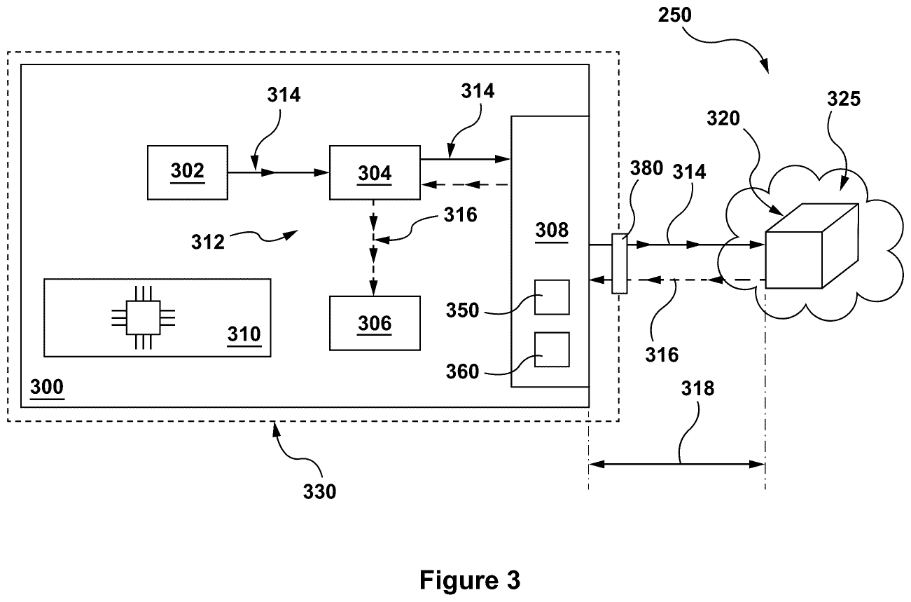

With reference to FIG. 3, there is depicted a schematic diagram of one particular embodiment of the LIDAR system 300 implemented in accordance with certain non-limiting embodiments of the present technology.

Broadly speaking, the LIDAR system 300 includes a variety of internal components including, but not limited to: (i) a light source 302 (also referred to as a “laser source” or a “radiation source”), (ii) a beam splitting element 304, (iii) a scanning unit 308 (also referred to as a “scanner”, and “scanner assembly”), (iv) a detection unit 306 (also referred to herein as a “detection system”, “receiving assembly”, or a “detector”), and (v) a controller 310. It is contemplated that in addition to the components non-exhaustively listed above, the LIDAR system 300 could include a variety of sensors (such as, for example, a temperature sensor, a moisture sensor, etc.) which are omitted from FIG. 3 for sake of clarity.

In certain non-limiting embodiments of the present technology, one or more of the internal components of the LIDAR system 300 are disposed in a common housing 330 as depicted in FIG. 3. In some embodiments of the present technology, the controller 310 could be located outside of the common housing 330 and communicatively connected to the components therein. As it will become apparent from the description herein further below, the housing 330 has a window 380 towards the surroundings of the vehicle 220 for allowing beams of light exiting the housing 330 and entering the housing 330.

Generally speaking, the LIDAR system 300 operates as follows: the light source 302 of the LIDAR system 300 emits pulses of light, forming an output beam 314; the scanning unit 308 scans the output beam 314 through the window 380 across the surroundings 250 of the vehicle 220 for locating/capturing data of a priori unknown objects (such as an object 320) therein, for example, for generating a multi-dimensional map of the surroundings 250 where objects (including the object 320) are represented in a form of one or more data points. The light source 302 and the scanning unit 308 will be described in more detail below.

As certain non-limiting examples, the object 320 may include all or a portion of a person, vehicle, motorcycle, truck, train, bicycle, wheelchair, pushchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects.

Further, let it be assumed that the object 320 is located at a distance 318 from the LIDAR system 300. Once the output beam 314 reaches the object 320, the object 320 generally reflects at least a portion of light from the output beam 314, and some of the reflected light beams may return back towards the LIDAR system 300, to be received in the form of an input beam 316. By reflecting, it is meant that at least a portion of light beam from the output beam 314 bounces off the object 320. A portion of the light beam from the output beam 314 may be absorbed or scattered by the object 320.

Accordingly, the input beam 316 is captured and detected by the LIDAR system 300 via the detection unit 306. In response, the detection unit 306 is then configured to generate one or more representative data signals. For example, the detection unit 306 may generate an output electrical signal (not depicted) that is representative of the input beam 316. The detection unit 306 may also provide the so-generated electrical signal to the controller 310 for further processing. Finally, by measuring a time between emitting the output beam 314 and receiving the input beam 316 the distance 318 to the object 320 is calculated by the controller 310.

As will be described in more detail below, the beam splitting element 304 is utilized for directing the output beam 314 from the light source 302 to the scanning unit 308 and for directing the input beam 316 from the scanning unit to the detection unit 306.

Use and implementations of these components of the LIDAR system 300, in accordance with certain non-limiting embodiments of the present technology, will be described immediately below.

### Light Source

The light source 302 is communicatively coupled to the controller 310 and is configured to emit light having a given operating wavelength. To that end, in certain non-limiting embodiments of the present technology, the light source 302 could include at least one laser pre-configured for operation at the given operating wavelength. The given operating wavelength of the light source 302 may be in the infrared, visible, and/or ultraviolet portions of the electromagnetic spectrum. For example, the light source 302 may include at least one laser with an operating wavelength between about 650 nm and 1150 nm. Alternatively, the light source 302 may include a laser diode configured to emit light at a wavelength between about 800 nm and about 1000 nm, between about 850 nm and about 950 nm, or between about 1300 nm and about 1600 nm. In certain other embodiments, the light source 302 could include a light emitting diode (LED).

The light source 302 of the LIDAR system 300 is generally an eye-safe laser, or put another way, the LIDAR system 300 may be classified as an eye-safe laser system or laser product. Broadly speaking, an eye-safe laser, laser system, or laser product may be a system with some or all of: an emission wavelength, average power, peak power, peak intensity, pulse energy, beam size, beam divergence, exposure time, or scanned output beam such that emitted light from this system presents little or no possibility of causing damage to a person's eyes.

According to certain non-limiting embodiments of the present technology, the operating wavelength of the light source 302 may lie within portions of the electromagnetic spectrum that correspond to light produced by the Sun. Therefore, in some cases, sunlight may act as background noise, which can obscure the light signal detected by the LIDAR system 300. This solar background noise can result in false-positive detections and/or may otherwise corrupt measurements of the LIDAR system 300. Although it may be feasible in some cases to increase a Signal-to-Noise Ratio (SNR) of the LIDAR system 300 by increasing the power level of the output beam 314, this may not be desirable in at least some situations. For example, it may not in some implementations be desirable to increase power levels of the output beam 314 to levels beyond eye-safe thresholds.

The light source 302 includes a pulsed laser configured to produce, emit, or radiate pulses of light with a certain pulse duration. For example, in some non-limiting embodiments of the present technology, the light source 302 may be configured to emit pulses with a pulse duration (e.g., pulse width) ranging from 10 ps to 100 ns. In other non-limiting embodiments of the present technology, the light source 302 may be configured to emit pulses at a pulse repetition frequency of approximately 100 kHz to 5 MHz or a pulse period (e.g., a time between consecutive pulses) of approximately 200 ns to 10 μs. Overall, however, the light source 302 can generate the output beam 314 with any suitable average optical power, and the output beam 314 may include optical pulses with any suitable pulse energy or peak optical power for a given application.

In some non-limiting embodiments of the present technology, the light source 302 could include one or more laser diodes, including but not limited to: Fabry-Perot laser diode, a quantum well laser, a distributed Bragg reflector (DBR) laser, a distributed feedback (DFB) laser, or a vertical-cavity surface-emitting laser (VCSEL). Just as examples, a given laser diode operating in the light source 302 may be an aluminum-gallium-arsenide (AlGaAs) laser diode, an indium-gallium-arsenide (InGaAs) laser diode, or an indium-gallium-arsenide-phosphide (InGaAsP) laser diode, or any other suitable laser diode. It is also contemplated that the light source 302 may include one or more laser diodes that are current-modulated to produce optical pulses.

In some non-limiting embodiments of the present technology, the light source 302 is generally configured to emit the output beam 314 that is a collimated optical beam, but it is contemplated that the beam produced could have any suitable beam divergence for a given application. Broadly speaking, divergence of the output beam 314 is an angular measure of an increase in beam cross-section size (e.g., a beam radius or beam diameter) as the output beam 314 travels away from the light source 302 or the LIDAR system 300. In some non-limiting embodiments of the present technology, the output beam 314 may have a substantially circular cross-section.

It is also contemplated that the output beam 314 emitted by light source 302 could be unpolarized or randomly polarized, could have no specific or fixed polarization (e.g., the polarization may vary with time), or could have a particular polarization (e.g., the output beam 314 may be linearly polarized, elliptically polarized, or circularly polarized).

In at least some non-limiting embodiments of the present technology, the output beam 314 and the input beam 316 may be substantially coaxial. In other words, the output beam 314 and input beam 316 may at least partially overlap or share a common propagation axis, so that the input beam 316 and the output beam 314 travel along substantially the same optical path (albeit in opposite directions). Nevertheless, in other non-limiting embodiments of the present technology, the output beam 314 and the input beam 316 may not be coaxial, or in other words, may not overlap or share a common propagation axis inside the LIDAR system 300, without departing from the scope of the present technology.

It should be noted that in at least some non-limiting embodiments of the present technology, the light source 302 could be rotatable, such as by 360 degrees or less, about the axis of rotation (not depicted) of the LIDAR system 300 when the LIDAR system 300 is implemented in a rotatable configuration. However, in other embodiments, the light source 302 may be stationary even when the LIDAR system 300 is implemented in a rotatable configuration, without departing from the scope of the present technology.

### Beam Splitting Element

With continued reference to FIG. 3, there is further provided the beam splitting element 304 disposed in the housing 330. For example, as previously mentioned, the beam splitting element 304 is configured to direct the output beam 314 from the light source 302 towards the scanning unit 308. The beam splitting element 304 is also arranged and configured to direct the input beam 316 reflected off the object 320 to the detection unit 306 for further processing thereof by the controller 310.

However, in accordance with other non-limiting embodiments of the present technology, the beam splitting element 304 may be configured to split the output beam 314 into at least two components of lesser intensity including a scanning beam (not separately depicted) used for scanning the surroundings 250 of the LIDAR system 300, and a reference beam (not separately depicted), which is further directed to the detection unit 306.

In other words, in these embodiments, the beam splitting element 304 can be said to be configured to divide intensity (optical power) of the output beam 314 between the scanning beam and the reference beam. In some non-limiting embodiments of the present technology, the beam splitting element 304 may be configured to divide the intensity of the output beam 314 between the scanning beam and the reference beam equally. However, in other non-limiting embodiments of the present technology, the beam splitting element 304 may be configured to divide the intensity of the output beam 314 at any predetermined splitting ratio. For example, the beam splitting element 304 may be configured to use up to 80% of the intensity of the output beam 314 for forming the scanning beam, and the remainder of up to 20% of the intensity of the output beam 314—for forming the reference beam. In yet other non-limited embodiments of the present technology, the beam splitting element 304 may be configured to vary the splitting ratio for forming the scanning beam (for example, from 1% to 95% of the intensity of the output beam 314).

It should further be noted that some portion (for example, up to 10%) of the intensity of the output beam 314 may be absorbed by a material of the beam splitting element 304, which depends on a particular configuration thereof.

Depending on the implementation of the LIDAR system 300, the beam splitting element 304 could be provided in a variety of forms, including but not limited to: a glass prism-based beam splitter component, a half-silver mirror-based beam splitter component, a dichroic mirror prism-based beam splitter component, a fiber-optic-based beam splitter component, and the like.

Thus, according to the non-limiting embodiments of the present technology, a non-exhaustive list of adjustable parameters associated with the beam splitting element 304, based on a specific application thereof, may include, for example, an operating wavelength range, which may vary from a finite number of wavelengths to a broader light spectrum (from 1200 to 1600 nm, as an example); an income incidence angle; polarizing/non-polarizing, and the like.

In a specific non-limiting example, the beam splitting element 304 can be implemented as a fiber-optic-based beam splitter component that may be of a type available from OZ Optics Ltd. of 219 Westbrook Rd Ottawa, Ontario KOA 1L0 Canada. It should be expressly understood that the beam splitting element 304 can be implemented in any other suitable equipment.

### Internal Beam Paths

As is schematically depicted in FIG. 3, the LIDAR system 300 forms a plurality of internal beam paths 312 along which the output beam 314 (generated by the light source 302) and the input beam 316 (received from the surroundings 250) propagate. Specifically, light propagates along the internal beam paths 312 as follows: the light from the light source 302 passes through the beam splitting element 304, to the scanning unit 308 and, in turn, the scanning unit 308 directs the output beam 314 outward towards the surroundings 250.

Similarly, the input beam 316 follows the plurality of internal beam paths 312 to the detection unit 306. Specifically, the input beam 316 is directed by the scanning unit 308 into the LIDAR system 300 through the beam splitting element 304, toward the detection unit 306. In some implementations, the LIDAR system 300 could be arranged with beam paths that direct the input beam 316 directly from the surroundings 250 to the detection unit 306 (without the input beam 316 passing through the scanning unit 308).

It should be noted that, in various non-limiting embodiments of the present technology, the plurality of internal beam paths 312 may include a variety of optical components. For example, the LIDAR system 300 may include one or more optical components configured to condition, shape, filter, modify, steer, or direct the output beam 314 and/or the input beam 316. For example, the LIDAR system 300 may include one or more lenses, mirrors, filters (e.g., band pass or interference filters), optical fibers, circulators, beam splitters, polarizers, polarizing beam splitters, wave plates (e.g., half-wave or quarter-wave plates), diffractive elements, microelectromechanical (MEM) elements, collimating elements, or holographic elements.

It is contemplated that in at least some non-limiting embodiments of the present technology, the given internal beam path and the other internal beam path from the plurality of internal beam paths 312 may share at least some common optical components, however, this might not be the case in each and every embodiment of the present technology.

### Scanning Unit

Generally speaking, the scanning unit 308 steers the output beam 314 in one or more directions downrange towards the surroundings 250. The scanning unit 308 is communicatively coupled to the controller 310. As such, the controller 310 is configured to control the scanning unit 308 so as to guide the output beam 314 in a desired direction downrange and/or along a predetermined scan pattern. Broadly speaking, in the context of the present specification “scan pattern” may refer to a pattern or path along which the output beam 314 is directed by the scanning unit 308 during operation.

In certain non-limiting embodiments of the present technology, the controller 310 is configured to cause the scanning unit 308 to scan the output beam 314 over a variety of horizontal angular ranges and/or vertical angular ranges; the total angular extent over which the scanning unit 308 scans the output beam 314 is sometimes referred to as the field of view (FOV). It is contemplated that the particular arrangement, orientation, and/or angular ranges could depend on the particular implementation of the LIDAR system 300. The field of view generally includes a plurality of regions of interest (ROIs), defined as portions of the FOV which may contain, for instance, objects of interest. In some implementations, the scanning unit 308 can be configured to further investigate a selected region of interest (ROI) 325. The ROI 325 of the LIDAR system 300 may refer to an area, a volume, a region, an angular range, and/or portion(s) of the surroundings 250 about which the LIDAR system 300 may be configured to scan and/or can capture data.

It should be noted that a location of the object 320 in the surroundings 250 of the vehicle 220 may be overlapped, encompassed, or enclosed at least partially within the ROI 325 of the LIDAR system 300.

According to certain non-limiting embodiments of the present technology, the scanning unit 308 may be configured to scan the output beam 314 horizontally and/or vertically, and as such, the ROI 325 of the LIDAR system 300 may have a horizontal direction and a vertical direction. For example, the ROI 325 may be defined by 45 degrees in the horizontal direction, and by 45 degrees in the vertical direction. In some implementations, different scanning axes could have different orientations.

The scanning unit 308 may include a first reflective component 350 and a second reflective component 360. The first reflective component 350 may be configured to redirect the output beam 314 from the beam splitting component towards the second reflective component 360 while spreading the output beam along a first axis. The second reflective component 360 may be configured to redirect the output beam 314 from the first reflective component 350 towards the surroundings 250 (through the window 380 of the housing 330) while spreading the output beam along a second axis. The second axis can be perpendicular and/or orthogonal to the first axis. As such, so-redirecting and so-spreading the output beam 314 by the combination of the first reflective component 350 and the second reflective component 360 may allow to scan the surroundings 250 of the vehicle 220 along at least two perpendicular/orthogonal axes.

It can be said that the scanning unit may scan the surroundings along a pair of axes. For example, the output beam 314 may be spread by the first reflective component 350 along a first axis and by the second reflective component 360 along a second axis. In one embodiment, the first axis may be a vertical axis while the second axis may be a horizontal axis. In an other embodiment, the first axis may be a horizontal axis while the second axis may be a vertical axis.

In certain non-limiting embodiments of the present technology, a given scanning unit may further include a variety of other optical components and/or mechanical-type components for performing the scanning of the output beam. For example, the given scanning unit may include one or more mirrors, prisms, lenses, MEM components, piezoelectric components, optical fibers, splitters, diffractive elements, collimating elements, and the like. It should be noted that the scanning unit may also include one or more additional actuators (not separately depicted) driving at least some of the other optical components to rotate, tilt, pivot, or move in an angular manner about one or more axes, for example.

Returning to the description of FIG. 3, the LIDAR system 300 may thus make use of the predetermined scan pattern to generate a point cloud substantially covering the ROI 325 of the LIDAR system 300. Again, this point cloud of the LIDAR system 300 may be used to render a multi-dimensional map of objects in the surroundings 250 of the vehicle 220.

### Detection Unit

According to certain non-limiting embodiments of the present technology, the detection unit 306 is communicatively coupled to the controller 310 and may be implemented in a variety of ways. According to the present technology, the detection unit 306 includes a photodetector, but could include (but is not limited to) a photoreceiver, optical receiver, optical sensor, detector, optical detector, optical fibers, and the like. As mentioned above, in some non-limiting embodiments of the present technology, the detection unit 306 may be configured to acquire or detects at least a portion of the input beam 316 and produces an electrical signal that corresponds to the input beam 316. For example, if the input beam 316 includes an optical pulse, the detection unit 306 may produce an electrical current or voltage pulse that corresponds to the optical pulse detected by the detection unit 306.

It is contemplated that, in various non-limiting embodiments of the present technology, the detection unit 306 may be implemented with one or more avalanche photodiodes (APDs), one or more single-photon avalanche diodes (SPADs), one or more PN photodiodes (e.g., a photodiode structure formed by a p-type semiconductor and a n-type semiconductor), one or more PIN photodiodes (e.g., a photodiode structure formed by an undoped intrinsic semiconductor region located between p-type and n-type regions), and the like.

In some non-limiting embodiments, the detection unit 306 may also include circuitry that performs signal amplification, sampling, filtering, signal conditioning, analog-to-digital conversion, time-to-digital conversion, pulse detection, threshold detection, rising-edge detection, falling-edge detection, and the like. For example, the detection unit 306 may include electronic components configured to convert a received photocurrent (e.g., a current produced by an APD in response to a received optical signal) into a voltage signal. The detection unit 306 may also include additional circuitry for producing an analog or digital output signal that corresponds to one or more characteristics (e.g., rising edge, falling edge, amplitude, duration, and the like) of a received optical pulse.

### Controller

Depending on the implementation, the controller 310 may include one or more processors, an application-specific integrated circuit (ASIC), a field-programmable gate array (FPGA), and/or other suitable circuitry. The controller 310 may also include non-transitory computer-readable memory to store instructions executable by the controller 310 as well as data which the controller 310 may produce based on the signals acquired from other internal components of the LIDAR system 300 and/or may provide signals to the other internal components of the LIDAR system 300. The memory can include volatile (e.g., RAM) and/or non-volatile (e.g., flash memory, a hard disk) components. The controller 310 may be configured to generate data during operation and store it in the memory. For example, this data generated by the controller 310 may be indicative of the data points in the point cloud of the LIDAR system 300.

It is contemplated that, in at least some non-limiting embodiments of the present technology, the controller 310 could be implemented in a manner similar to that of implementing the electronic device 210 and/or the computer system 100, without departing from the scope of the present technology. In addition to collecting data from the detection unit 306, the controller 310 could also be configured to provide control signals to, and potentially receive diagnostics data from, the light source 302 and the scanning unit 308.

As previously stated, the controller 310 is communicatively coupled to the light source 302, the scanning unit 308, and the detection unit 306. In some non-limiting embodiments of the present technology, the controller 310 may be configured to receive electrical trigger pulses from the light source 302, where each electrical trigger pulse corresponds to the emission of an optical pulse by the light source 302. The controller 310 may further provide instructions, a control signal, and/or a trigger signal to the light source 302 indicating when the light source 302 is to produce optical pulses indicative, for example, of the output beam 314.

Just as an example, the controller 310 may be configured to send an electrical trigger signal that includes electrical pulses, so that the light source 302 emits an optical pulse, representable by the output beam 314, in response to each electrical pulse of the electrical trigger signal. It is also contemplated that the controller 310 may cause the light source 302 to adjust one or more characteristics of output beam 314 produced by the light source 302 such as, but not limited to: frequency, period, duration, pulse energy, peak power, average power, and wavelength of the optical pulses.

By the present technology, the controller 310 is configured to determine a “time-of-flight” value for an optical pulse in order to determine the distance between the LIDAR system 300 and one or more objects in the field of view, as will be described further below. The time of flight is based on timing information associated with (i) a first moment in time when a given optical pulse (for example, of the output beam 314) was emitted by the light source 302, and (ii) a second moment in time when a portion of the given optical pulse (for example, from the input beam 316) was detected or received by the detection unit 306. In some non-limiting embodiments of the present technology, the first moment may be indicative of a moment in time when the controller 310 emits a respective electrical pulse associated with the given optical pulse; and the second moment in time may be indicative of a moment in time when the controller 310 receives, from the detection unit 306, an electrical signal generated in response to receiving the portion of the given optical pulse from the input beam 316.

In other non-limiting embodiments of the present technology, where the beam splitting element 304 is configured to split the output beam 314 into the scanning beam (not depicted) and the reference beam (not depicted), the first moment in time may be a moment in time of receiving, from the detection unit 306, a first electrical signal generated in response to receiving a portion of the reference beam. Accordingly, in these embodiments, the second moment in time may be determined as the moment in time of receiving, by the controller 310 from the detection unit 306, a second electrical signal generated in response to receiving an other portion of the given optical pulse from the input beam 316.

By the present technology, the controller 310 is configured to determine, based on the first moment in time and the second moment in time, a time-of-flight value and/or a phase modulation value for the emitted pulse of the output beam 314. The time-of-light value T, in a sense, a “round-trip” time for the emitted pulse to travel from the LIDAR system 300 to the object 320 and back to the LIDAR system 300. The controller 310 is thus broadly configured to determine the distance 318 in accordance with the following equation:

$$D = \frac{c \cdot T}{2} , \qquad ( 1 )$$

wherein D is the distance 318, T is the time-of-flight value, and c is the speed of light (approximately 3.0×10⁸ m/s).

As previously alluded to, the LIDAR system 300 may be used to determine the distance 318 to one or more other potential objects located in the surroundings 250. By scanning the output beam 314 across the ROI 325 of the LIDAR system 300 in accordance with the predetermined scan pattern, the controller 310 is configured to map distances (similar to the distance 318) to respective data points within the ROI 325 of the LIDAR system 300. As a result, the controller 310 is generally configured to render these data points captured in succession (e.g., the point cloud) in a form of a multi-dimensional map. In some implementations, data related to the determined time of flight and/or distances to objects could be rendered in different informational formats.

As an example, this multi-dimensional map may be used by the electronic device 210 for detecting, or otherwise identifying, objects or determining a shape or distance of potential objects within the ROI 325 of the LIDAR system 300. It is contemplated that the LIDAR system 300 may be configured to repeatedly/iteratively capture and/or generate point clouds at any suitable rate for a given application.

It should be noted that such multi-dimensional maps may be recorded and stored as part of log data associated with the vehicle 220. As a result, point cloud data captured by LIDAR systems in a fleet of vehicles may be stored for later use. Furthermore, multi-dimensional maps captured by a given LIDAR system are used to localize the SDC during operation. How point cloud data captured by the LIDAR system during operation may be used for localizing the vehicle 220 will become apparent from the description herein further below.

### Data Storage Device

With reference to FIG. 4, there is depicted the data storage device 400. The data storage device 400 may be communicatively coupled to the server 235 and the electronic device 210 of the vehicle 220 (see FIG. 2). The data storage device 400 may be used by the server 235 and/or the electronic device 210 for storing data gathered during operation of the vehicle 220. The data storage device 400 may be used by the server 235 and/or the electronic device 210 for determining at least a portion of stored data to be updated. The data storage device 400 may be used by the server 235 and/or the electronic device 210 for retrieving data to be used during operation of the vehicle 220.

In some embodiments of the present technology, the data storage device 400 may receive data collected by sensors of a plurality of vehicles 404, for example, hundreds or thousands of vehicles implemented similarly to the vehicle 220. The vehicles provide sensor data captured while driving along various routes and send it to the data storage device 400. As a result, it can be said that the data storage device 400 may store log data 406 for the plurality of vehicles 404 (a fleet of vehicles).

In other embodiments of the present technology, the server 235 may use the log data 406 for creating and/or updating a map representation 402 of a geographical region where the plurality of vehicles 404 are and/or have been operating. It is contemplated that the server 235 may build the map representation 402 of the geographical region maps based on the collective information received from the plurality of vehicles 404 and stores the map representation 402 in the data storage device 400.

The server 235 may be configured to send data representing of the map representation 402 to electronic devices associated with respective vehicles in the plurality of vehicles 404. For example, if the vehicle 220 needs to drive along a route, the electronic device 210 may provide information describing the route being travelled to the server 235. In response, the server 235 provides the map representation 402 (or portions thereof) for driving along the route. It is contemplated that the map representation 402 may be pushed periodically to be stored locally by the electronic device 210 for exploitation, without departing from the scope of the present technology.

In one embodiment, the server 235 sends portions of the map representation 402 to vehicles in a compressed format so that the data transmitted consumes less bandwidth. The server 235 may receive from various vehicles, information describing the data that is locally stored by the electronic device 210. If the server 235 determines that the vehicle 220 does not have a certain portion of the map representation 402 locally stored, the server 235 may send that portion of the map representation 402. If the server 235 determines that the vehicle 220 did previously receive that particular portion of the map representation but the corresponding data was updated by the server 235 since the vehicle 220 last received the data, the server 235 may send an update for that portion of the map representation 402 to the electronic device 210.

It should be noted that the server 235 may generate the map representation 402 based on the log data 406. The server 235 updates previously computed map data by receiving more recent information from vehicles that recently travelled along routes on which map information changed. In one embodiment, map aligning techniques using Iterative Closest Point (ICP) techniques (and variants thereof) may be used by the server 235 for relating points having the closest distance in different cloud maps from the log data 406 in order to combine them and extend or grow the map representation of the geographical region in which the cloud data from the log data 406 has been captured.

In at least some embodiments of the present technology, the server 235 may be configured to generate a 2D representation of a region based on a 3D representation of the region. For example, the server 235 may be configured to project a plurality of vertical points onto an element of a 2D grid. Different characteristics of with the plurality of vertical points may be sued for determining a value for the element. In one non-limiting example, intensity values from the plurality of vertical points may be combined for determining a value to be associated with the element of the 2D grid. It can be said that projection of the 3D points onto a 2D grid may result in generation of image data representative of various regions of a map. In at least some embodiments, it can be said that the data storage device 400 stores one or more images representative of the map.

Furthermore, the data storage device 400 may store additional data 410. In some embodiments, the additional data 410 comprises information indicative of ground-truth polygon boundaries provided by human assessors for at least some regions of the map representation 402. In other embodiments, a plurality of graph structures may be stored in the data storage device 400. For example, a graph structure representative of sidewalks may be stored in the data storage device 400. In another example, a graph structure representative of location of roads and the direction of travel of those roads may be stored in the data storage device 400. In a further example, a graph structure representative of paths that can be used by pedestrians and vehicles may be stored in the data storage device 400. In an additional example, a graph structure representative of crosswalks that can be used by pedestrians and relatively small robotic vehicles may be stored in the data storage device 400.

In some embodiments, it is contemplated that information indicative of one or more graph-structures may be stored in association with respective regions of the map representation. It is also contemplated that one or more graph-structures may be rasterized, and the resulting image data may be stored in association with respective regions of the map representation.

In some embodiments of the present technology, at least some image data may be stored as GeoTIFF files. Broadly speaking, GeoTIFF is a public domain metadata standard that enables georeferencing information to be embedded within an image file. The GeoTIFF format embeds geospatial metadata into image files such as aerial photography, satellite imagery, and digitized maps so that they can be used in GIS applications.

More particularly, a GeoTIFF file extension contains geographic metadata that describes the actual location in space that each pixel in an image represents. When a GeoTIFF file is generated, spatial information is included in the “.tif” file as embedded tags, which can include raster image metadata such as, but not limited to: horizontal and vertical datums, spatial extent (i.e., the area that the dataset covers), the coordinate reference system (CRS) used to store the data, spatial resolution measured in the number of independent pixel values per unit length, the number of layers in the “.tif” file, ellipsoids and geoids (e.g., estimated models of the Earth's shape), and mathematical rules for map projection to transform data for a 3D space into a 2D display.

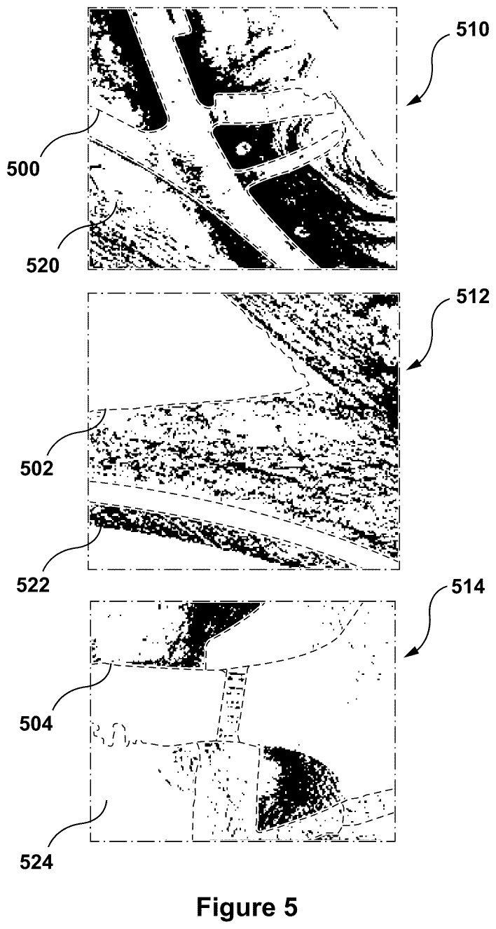

In FIG. 5, there is depicted a polygon 500 on an image 510 of a map region 520. As can be seen, the polygon 500 may have stepped borders. There is also shown a polygon 502 on an image 512 of a map region 522. As can be seen, the polygon 502 may have rounded corners and/or slightly under-stretched corners and borders. There is also shown a polygon 504 on an image 514 of a map region 524. As can be seen, the polygon 504 may have erroneous borders that do not correspond to reality. In this example, the images 510, 512 and 514 are GeoTIFF files.

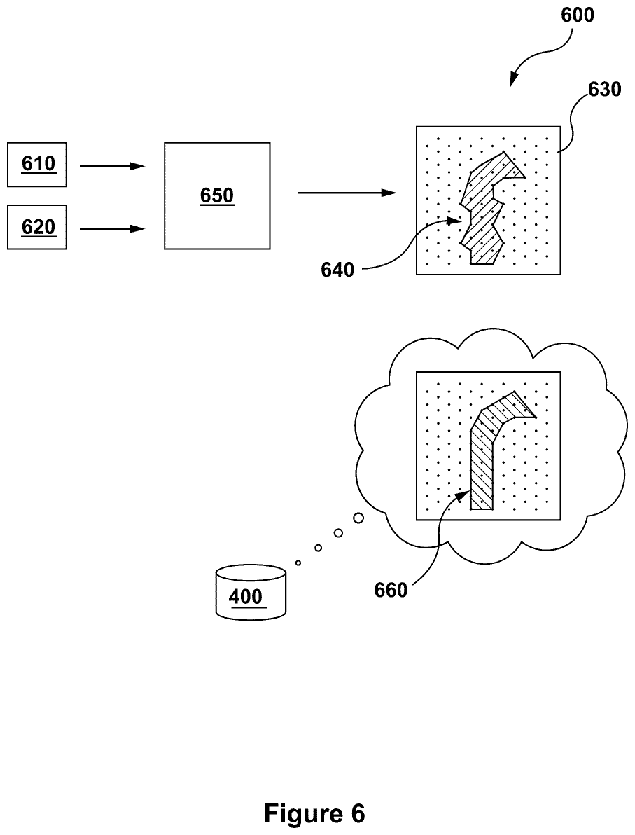

With reference to FIG. 6, there is depicted a representation 600 of how the segmentation model 650 is configured to generate a segmentation map 630 based on the image data 620. In some embodiments, the image data 620 may include a 2D representation of a region on a map. Such an image may be generated by projecting points from a 3D point cloud onto a 2D grid. In other embodiments, one or more additional image data channels 610 may be inputted into the segmentation model for generating the segmentation map 630. For example, one or more graph-structures may be rasterized and inputted as respective images into the segmentation model 650.

The segmentation map 630 includes a plurality of points (not numbered). Each of the plurality of points is associated with a respective feature vector generated by the segmentation model 650. For example, feature vectors may include features extracted from GeoTiff images by the segmentation model 650. It should be noted that a feature vector generated for a given pixel may be at least partially based on features generated for neighboring pixels.

Which pixels are neighboring pixels to the given pixels may be determined or depend on a specific implementation of the segmentation model 650. However, in at least some embodiments, the plurality of points may correspond to a sequence of points forming a polygon boundary, and where neighboring points for a given point in the sequence may include one or more preceding points and/or one or more following points relative to a given point in the sequence.

The segmentation map 630 also include an indication of a polygon boundary 640. It can be said that the polygon boundary 640 is an estimation of a portion of the segmentation map 630 that includes an object. It can be said that the polygon boundary 640 is an estimation of a perimeter that identifies the object in the region. The polygon boundary 640 includes a sequence of boundary points (not numbered).

The server 235 is configured to acquire a ground-truth polygon boundary 660 associated with the given object that is stored in the storage 400 in association with the region. As mentioned above, the ground-truth polygon boundary 660 has been provided by a human assessor (e.g., cartographer). For example, the human assessor may be tasked with manually identifying a sequence of boundary edges that represent a ground-truth location of the object in the region.

The server 235 may be configured to generate “labels” for respective points from the sequence of boundary points of the polygon boundary 640. These labels may be determined by mapping the ground-truth polygon boundary 660 onto the segmentation map 630 and compare boundary points from the polygon boundary 640 against edges from the ground-truth polygon boundary 660.

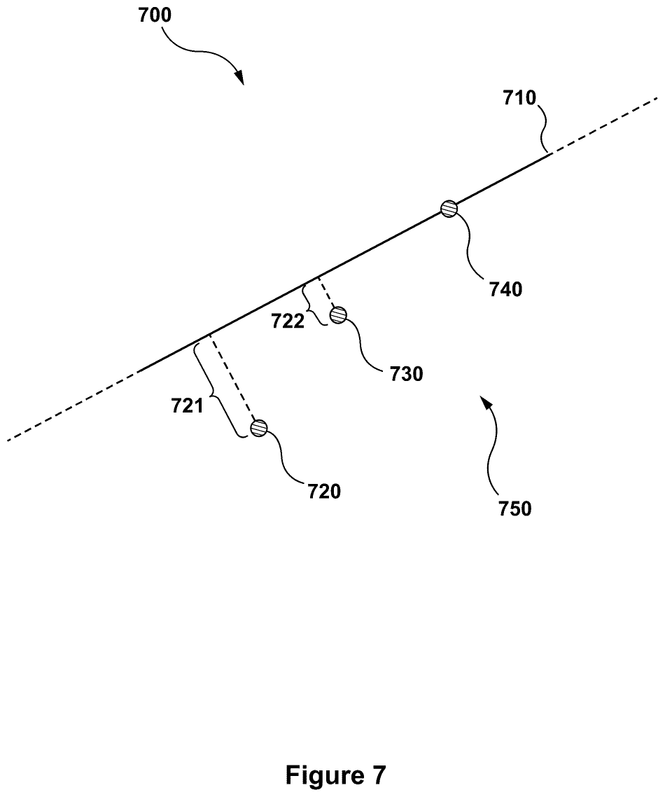

With reference to FIG. 7, there is depicted a representation 700 of how the server 235 may be configured to determine the labels for respective points from the polygon boundary 640. There is depicted an edge 710 from the sequence of edges of the ground-truth polygon boundary 660. There is also depicted a sub-sequence of boundary points 750 from the sequence of boundary points, including a first boundary point 720, a second boundary point 730, and a third boundary point 740.

It is contemplated that a position of a given boundary point in the sequence of boundary points may be defined as a change in position from a position of a preceding boundary point in the sequence of boundary points. For example, a position of the second boundary point 730 may be defined as a change in position from the position of the first boundary point 720, a position of the third boundary point 740 may be defined as a change in position form the position of the second boundary point 730, a subsequent boundary point in the sequence of boundary points may be defined as a change in position from the position of the third boundary point 740, and so forth.

The server 235 may be configured to determine a displacement between the position and a closest edge from the sequence of edges. It should be noted although in this non-limiting example illustrated on FIG. 7 the closest edge to the first boundary point 720, the second boundary point 730, and the third boundary point 740 is the edge 710, this may not be the case in each and every embodiment of the present technology. For example, each of the first boundary point 720, the second boundary point 730, and the third boundary point 740 may have different closest edges, respectively.

The server 235 may be configured to determine a first displacement 721 for the first boundary point 720, a second displacement 722 for the second boundary point 730, and may determine that the third boundary point 740 matches the edge 710 (e.g., a null displacement and/or that the edge 710 passes through a point on the segmentation map that matches in position with the third boundary point 740).

The server 235 may determine labels for respective ones from the subsequence of boundary points 750 based on the respective displacements. In some embodiments where the second model is configured to perform a classification task, the server 235 may determine whether a given displacement is below or above a pre-determined threshold. For example, the server 235 may determine a label indicative of a first class for the first boundary point 720 based on the first displacement 721 if the first displacement 721 is below the pre-determined threshold, and may determine a label indicative of a second class for the second boundary point 730 based on the first displacement 721 if the second displacement 722 is above the pre-determined threshold. For example, the pre-determined displacement threshold may be 20 cm.

In other embodiments where the second model is configured to perform a regression task, the server 235 may use a given displacement as the label for a respective boundary point. For example, the server 235 may determine labels for respective boundary points that are indicative of magnitude of offset (e.g., the displacements) for respective boundary points. As it will be discussed in greater details herein further below, in at least some embodiments, the second model may comprise more than one output heads where a first classification-dedicated head is configured to solve a classification task and a second regression-dedicated head is configured to solve a regression task, and where labels for both heads are generated based on displacements computed for respective boundary points.

It is contemplated that outputs of the regression-dedicated head may be employed in-use alone and/or in combination with the classification-dedicated head. For example, the outputs of the regression-dedicated head may be employed in-use for determining a magnitude of offset for a given boundary point. This may allow the server to automatically adjust the given boundary point for compensating for that magnitude of offset.

For example and without limitation, the second model may, upon performing a classification task, rely on convolutional networks based on 1D convolutions, recurrent networks and/or transformers with attention ML architectures. Convolutional networks based on 1D convolutions ML architectures may be implemented as described in “Encoder-Decoder with Atrous Separable Convolution for Semantic Image Segmentation” authored by Liang-Chieh Chen et al., and published in 2018, the contents of which is incorporated herein by reference in its entirety. Recurrent networks ML architectures may be implemented as described in “Sequence to Sequence Learning with Neural Networks” authored by Ilya Sutskever et al., and published in 2014, the contents of which is incorporated herein by reference in its entirety. Transformers with attention ML architectures may be implemented as described in “Attention is All you Need” authored by Ashish Vaswani et al., and published in 2017, the contents of which is incorporated herein by reference in its entirety.

In further embodiments, it is contemplated that the second model may have different portions for performing both a classification task and a regression task. In these embodiments, the server 235 may be configured to determine more than one label for a given boundary point. The more than one labels may include a first label indicative of a given displacement to the closest edge, and a second label indicative of whether the displacement is below or above a pre-determined threshold.

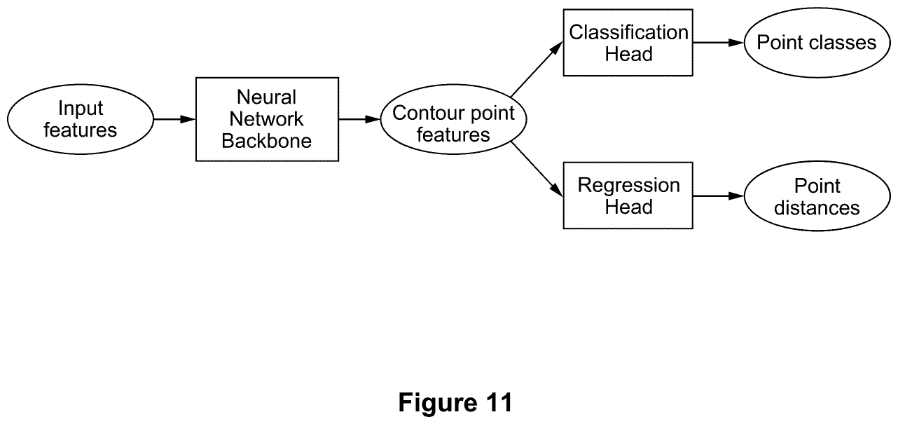

With reference to FIG. 11, there is depicted a schematic diagram of a ML architecture that can be used for implementing the second model where two channels of labels can be used, namely a first channel for first labels and a second channel for second labels.

More specifically, the ML architecture may include a neural network backbone fed with input features. In some implementations, the input features include a tensor whose size depends on a number of boundary points and a number of image features. For example, the size of the tensor may be [N×(2+K)], where N is (number of boundary points) and K is (number of raw features from the first model and each boundary point may be encoded by a difference in position relative to an immediately precedent boundary point in the sequence of boundary points, as well as a vector of raw features from the first network for the pixel corresponding to this boundary point.

The neural network backbone generates boundary point features that may be mapped by a tensor whose size depends on the number of boundary points and the number of image features. For example, the size of the tensor may be [N×M], where N is number of boundary points and M is number of features from the second model. The boundary point features may include raw features for each boundary point from which displacements and/or classes will be subsequently predicted.

As depicted on FIG. 11, the ML architecture further includes a classification-dedicated head and a regression-dedicated head that may be two different neural networks involved in predicting classes and displacements. In some implementations, the classification-dedicated head and the regression-dedicated head may form a multi-layer perceptron.

The classification head generates classes of the boundary points as a tensor of size [N×1] and the regression head generates displacements of the boundary points as a tensor of size [N×2]. Developers have realized that the classification-dedicated head may be trained based on a first channel of class labels (indicative of classes) and the regression-dedicated head may be trained based on a second channel of regression labels (indicative of magnitude of offset). It is contemplated that the server 235 may employ the regression-dedicated head depending on a predicted class of a given in-use dataset by the classification-dedicated head.

In some embodiments of the present technology, the second model may be implemented in accordance with the CatBoost algorithm. Broadly, CatBoost is a gradient boosting algorithm that is designed to process categorical features. CatBoost operates within the gradient boosting framework, a popular ensemble learning technique. The model builds an ensemble of decision trees iteratively to create a strong predictive model. Each tree corrects the errors of its predecessor, leading to improved overall predictions. In these embodiments, it is contemplated that a first CatBoost model may be trained and used for solving the classification task using the first channel of class labels, and a second CatBoost model may be trained and used for solving the regression task using the second channel of regression labels as described above. In these embodiments, the input data may comprise data indicative of respective neighborhood points determined by the server 235 for respective input points.

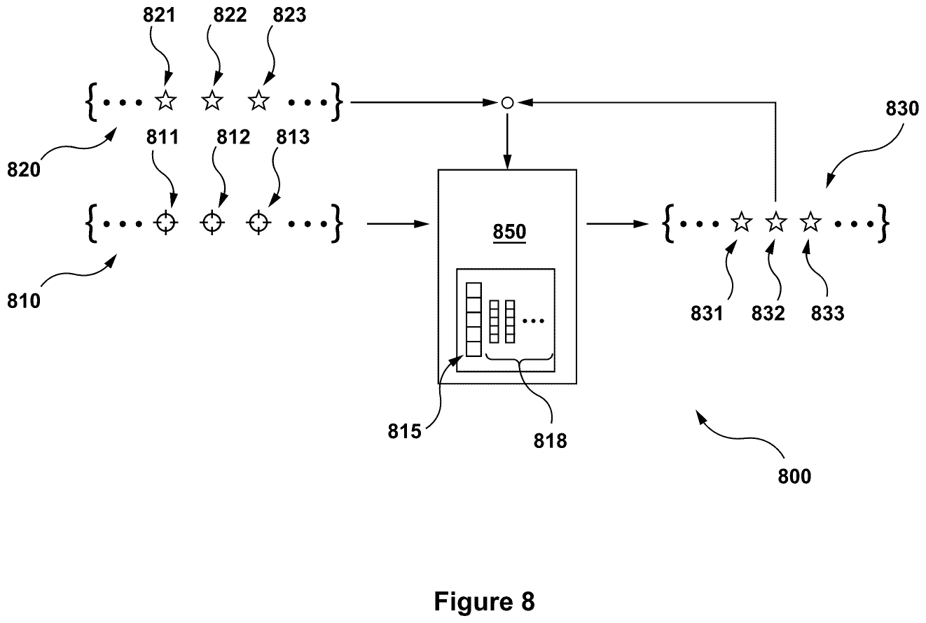

With reference to FIG. 8, there is depicted a representation 800 of a training procedure that the server 235 may perform on the second model 850 based on the polygon boundary 640 and the ground-truth polygon boundary 660.

The server 235 may be configured to generate training data based on (i) positions of boundary points from the sequence of boundary points, (ii) feature vectors associated with the respective boundary points from the sequence of boundary points, (iii) feature vectors of other points from the segmentation map that are “neighbors” of the boundary points from the sequence of boundary points, and (iv) the labels associated with the respective boundary points from the sequence of boundary points.

In FIG. 8, there is depicted a sequence of positions 810 corresponding to positions of the sequence of boundary points. Let it be assumed that positions 811, 812, and 813 correspond to positions of the first boundary point 720, of the second boundary point 730, and of the third boundary point 740, respectively.

It should be noted that the position 812 of the second boundary point 730 is associated with a feature vector 815 associated with the second boundary point 730 and a plurality of neighbouring feature vectors 818 associated with neighbouring points of the second boundary point 730. It can be said that the plurality of neighbouring feature vectors 818 represent a “context” of the second boundary point 730. It is contemplated that the model may be configured to determine the plurality of neighbouring feature vectors 818 based on neighboring points.

Neighbor selection may depend on inter alia specific implementations of UNet (which processes contour points)—the number of layers, parameters and connections between the layers may be used for controlling a size of the neighborhood. For example, points can be uniformly sampled on the contour and then a full-convolution network with 1D convolutions can be launched thereon. Depending on a number of convolutions and their parameters, a given point will in a sense “look” at a given neighborhood of a given size. For example, one 1d convolution with a core 3 configuration may result in the given point knowing about a neighborhood of radius 1, one convolution with core 5 configuration may result in the given point knowing about a neighborhood of radius 2, two consecutive convolutions of size 5 configuration may result in the given point knowing about a neighbourhood of radius 4.

The server 235 may be configured to input respective positions from the sequence of positions 810 with feature vectors to the second model 850 that generates respective prediction scores from a sequence of prediction scores 830. For example, the second model 850 may be configured to generate a prediction score 832 for the position 812 and the respective feature vectors.

The server 235 is configured to compare respective predictions scores from the sequence of prediction scores 830 against a sequence of labels 820. For example, the sequence of labels 820 may including labels 821, 822, and 823 for the respective ones from the first boundary point 720, the second boundary point 730, and the third boundary point 740. As such, the server 235 may compare the prediction score 832 against the label 822. The server 235 may be configured to adjust the second model 850 based on these comparisons between prediction values and labels.

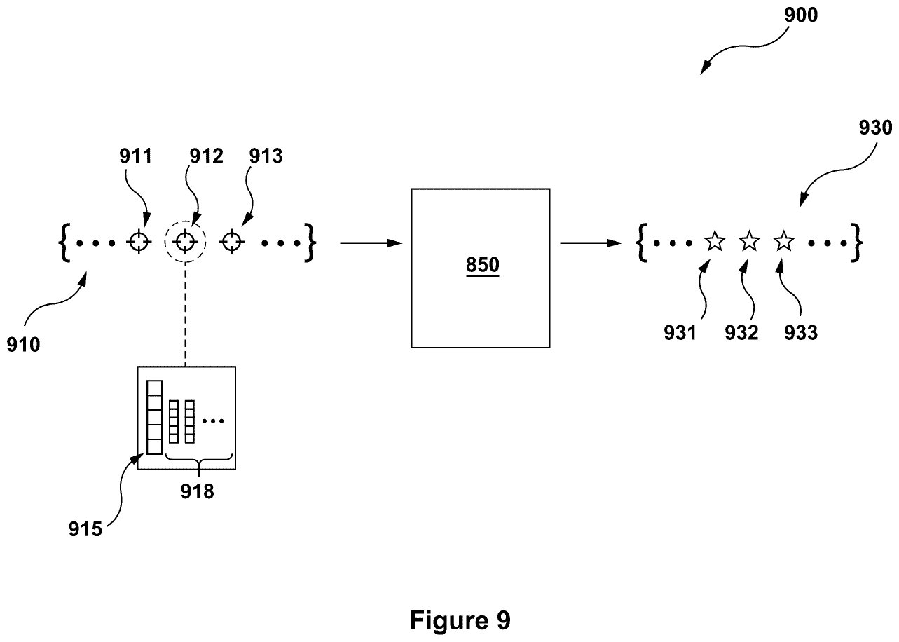

With reference to FIG. 9, there is depicted a representation 900 of an in-use operation of the second model 850. The second model 850 may be configured to receive a sequence of positions 910 corresponding to positions of a sequence of boundary points from an in-use polygon generated by the segmentation model 650 in a non-assessed region of the map. The sequence of positions 910 includes positions 911, 912, and 913.

It should be noted that the position 912 a corresponding boundary point of the in-use polygon is associated with a feature vector 915 associated with corresponding second boundary point and a plurality of neighbouring feature vectors 918 associated with neighbouring points of the given boundary point. It can be said that the plurality of neighbouring feature vectors 918 represent a “context” of the corresponding boundary point.

The server 235 may be configured to input respective positions from the in-use sequence of positions 910 with feature vectors to the second model 850 that generates respective in-use prediction scores (confidence scores) from a sequence of prediction scores 930. For example, the second model 850 may be configured to generate a prediction score 932 for the position 912 and the respective feature vectors.

In some embodiments, if one or more of the prediction scores from the sequence of predictions scores 930 is indicative of that the respective in-use boundary points have been erroneously positioned, the server 235 may identify the in-use polygon (and/or a portion thereof) and/or the non-assessed region of the map for future human assessment.

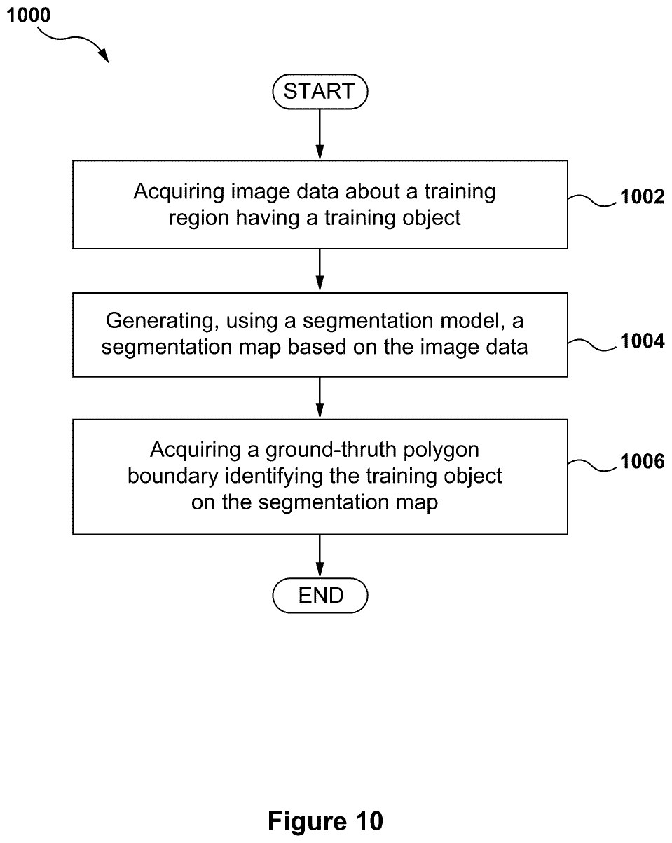

With reference to FIG. 10, there is depicted a flowchart of a method 1000 executable by a processor (e.g., a processor of the server 235). Various steps of the method 1000 will now be described in greater detail.

Step 1002: Acquiring Image Data about a Training Region Having a Training Object

The method 1000 begins at step 1002 with the processor acquiring image data about a training region having a training object. In some embodiments, the training object is one of a road segment, and a sidewalk segment. It should be noted that image data about the training region and data about the training object may be used for operating a vehicle in the training region. In some embodiments, the vehicle may be a SDC operating on road segments. In other embodiments, the vehicle may be a delivery robot operating on sidewalk segments.

It is contemplated that the image data may comprise a plurality of image data files. In some embodiments, the image data may comprise a birds-eye view representation of the training region. In other embodiments, the image data may comprise a 2D image of the training region having been generated by the processor from a 3D point cloud representative of the training region. In further embodiments, the image data may comprise one or more raster images.

### Step 1004: Generating, Using a Segmentation Model, a Segmentation Map Based on the Image Data

The method 1000 continues to step 1004 with the processor configured to generate, using the segmentation model 650, a segmentation map based on the image data. The segmentation model 650 can be an MLA configured to perform image data segmentation. In some embodiments, it is contemplated that the segmentation model 650 may be configured to inter alia assign labels to respective pixels of an inputted image and such that pixels with a same label share some characteristic(s). In one example, pixels associated with a given label may be representative of a same object in the inputted image. It is also contemplated that a variety of algorithms could be applied onto the labelled pixels for determining a contour, or “boundary”, of the given object in the inputted image.

In some embodiments of the present technology, the segmentation model 650 may be implemented as a Convolutional Neural Network (CNN) trained for image segmentation applications. In one embodiment, the CNN may have a “U-Net” architecture.

As such, it can be said that the output of the segmentation model 650, the segmentation map, may include a plurality of points defining a training polygon boundary. The output of the segmentation model 650 may include for the plurality of points respectively associated feature vectors.

The training polygon boundary generated by the segmentation model 650 can be a computer-generated boundary that is an attempt to identify the training object in the training region. The training polygon boundary includes a sequence of boundary points, and where a position of a given boundary point in the sequence is defined as a change in position from a position of a preceding boundary point in the sequence.

### Step 1006: Acquiring a Ground-Truth Polygon Boundary Identifying the Training Object on the Segmentation Map

The method 1000 continues to step 1006 with the processor is configured to acquire a ground-truth polygon boundary identifying the training object on the segmentation map. The ground-truth polygon boundary includes a sequence of boundary edges identified by a human assessor (e.g., cartographer). The data indicative of the ground-truth polygon boundary may be stored in the storage 400 in association with the training region. In some embodiments, the human assessor may be tasked with manually identifying a sequence of boundary edges that represent a ground-truth location of the training object in the training region.

Step 1008: For the Given Boundary Point in the Sequence, Determining a Displacement Between the Position and a Closest Edge from the Sequence of Edges, the Displacement being Indicative of a Label for the Given Boundary Point

The method 1000 continues to step 1008 with the processor configured to, for a given boundary point in the sequence of boundary points of the training polygon boundary, determine a displacement between the position and a closest edge from the sequence of edges of the ground-truth polygon boundary. It should be noted that the so-determined displacement is indicative of a label for the given boundary point to be used for training a second model.

### Step 1010: Training a Second Model for Predicting a Confidence Score for an In-Use Boundary Point of an In-Use Polygon Boundary

The method 1000 continues to step 1010 with the processor configured to for the given boundary point in the sequence, training the second model 850 for predicting a confidence score for an in-use boundary point of an in-use polygon boundary.

The training includes, during a given training iteration, using, by the second model, the position of the given boundary point, the feature vector associated with the given boundary point, and a set of feature vectors of neighboring points on the segmentation map representative of a context of the given boundary point, for generating a predicted score. The training includes, during a given training iteration, adjusting the second model 850 based on a comparison between the predicted score and the label.

In some embodiments, it is contemplated that the set of feature vectors of neighboring points may correspond to feature vectors of neighboring points along the polygon boundary (e.g., sequence of boundary points). For example, the neighboring points may comprise one or more preceding boundary points and/or one or more following boundary points along the sequence of boundary points forming the polygon boundary.

In some embodiments, the second model 850 is a classification model, and wherein the label is indicative of a first class if the displacement is below a pre-determined threshold and is indicative of a second class if the displacement if above the pre-determined threshold, the first class being a high confidence class and the second class being a low confidence class. The pre-determined threshold may be 20 cm, for example.

In other embodiments, however, it is contemplated that the second model 850 may have different portions, or different “heads”, for performing both a classification task and a regression task. In these embodiments, the processor may be configured to determine more than one label for a given boundary point. The more than one labels may include a first label indicative of a given displacement to the closest edge, and a second label indicative of whether the displacement is below or above a pre-determined threshold.

It is contemplated that the processor can acquire in-use image data about an in-use region having an in-use object not having been assessed by the human assessor. The processor may generate, using the segmentation model 650, an in-use segmentation map defining the in-use polygon boundary, similarly to how the segmentation model 650 generates the training polygon. The processor may then use the now-trained the second model 850 to generate an in-use confidence score for a given in-use boundary point from the sequence of in-use boundary points. In response to the confidence score being indicative of a low confidence (a given class and/or being below a given threshold value), the processor can automatically identify at least a portion of the in-use region for human assessment and acquire a ground-truth polygon boundary of the in-use object from the human assessor.

It should be noted that polygon boundaries may be transmitted from the server 235 to the electronic device 210 associated with a vehicle for navigation purposes. For example, one or more navigation and/or control algorithms running on the electronic device 210 may employ polygon boundaries of one or more entities in a map region for navigating and/or controlling operation of the vehicle in that map region.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of classifying points on a polygon boundary, the method being executed by a processor, the method comprising:
acquiring, by the processor, image data about a training region having a training object;
generating, by the processor using a segmentation model, a segmentation map based on the image data,
the segmentation map including a plurality of points and defining a training polygon boundary, the plurality of points being associated with a respective feature vector generated by the segmentation model,
the training polygon boundary identifying the training object in the training region, the training polygon boundary including a sequence of boundary points, a position of a given boundary point in the sequence being defined as a change in position from a position of a preceding boundary point in the sequence;
acquiring, by the processor, a ground-truth polygon boundary identifying the training object on the segmentation map, the ground-truth polygon boundary including a sequence of boundary edges identified by a human assessor;
for the given boundary point in the sequence, determining a displacement between the position and a closest edge from the sequence of edges, the displacement being indicative of a label for the given boundary point;
training, by the processor, a second model for predicting a confidence score for an in-use boundary point of an in-use polygon boundary, the training including, during a given training iteration:
using, by the second model, the position of the given boundary point, the feature vector associated with the boundary point, and a set of feature vectors of neighboring points on the segmentation map representative of a context of the given boundary point, for generating a predicted score;
adjusting the second model based on a comparison between the predicted score and the label.

2. The method of claim 1, wherein the method further comprises:
acquiring, by the processor, in-use image data about an in-use region having an in-use object, the in-use object not having been assessed by the human assessor for generating a ground-truth polygon boundary identifying the in-use object;
generating, by the processor using the segmentation model, an in-use segmentation map defining the in-use polygon boundary, the in-use polygon boundary including a sequence of in-use boundary points; and
generating, by the processor using the second model, the confidence score for the in-use boundary point from the sequence of in-use boundary points; and
in response to the confidence score being indicative of a low confidence, automatically identifying at least a portion of the in-use region for human assessment; and
acquiring, by the processor, the ground-truth polygon boundary of the in-use object from the human assessor.

3. The method of claim 1, wherein the training object is one of a road segment, and a sidewalk segment.

4. The method of claim 1, wherein the image data comprises a birds-eye view representation of the training region.

5. The method of claim 1, wherein the image data comprises a 2D image of the training region, the 2D image being generated from a 3D point cloud representative of the training region.

6. The method of claim 1, wherein the image data comprises one or more raster images.

7. The method of claim 1, wherein the segmentation model is a fully convolutional neural network.

8. The method of claim 1, wherein the second model is a classification model, and wherein the label is indicative of a first class if the displacement is below a pre-determined threshold and is indicative of a second class if the displacement if above the pre-determined threshold, the first class being a high confidence class and the second class being a low confidence class.

9. The method of claim 1, wherein the second model has two heads, a first head being trained based on a first label indicative of a given displacement to the closest edge, and a second head being trained on a second label indicative of whether the displacement is below or above a pre-determined threshold.

10. The method of claim 1, wherein the in-use polygon boundary is stored in association with the in-use region, and wherein the in-use polygon boundary is transmitted to a second processor associated with a vehicle for navigating the vehicle in the in-use region.

11. The method of claim 10, wherein the vehicle is a Self-Driving Car (SDC) operating on road segments.

12. The method of claim 10, wherein the vehicle is a delivery robot operating on sidewalk segments.

13. A processor for classifying points on a polygon boundary, the processor being configured to:
acquire image data about a training region having a training object;
generate, using a segmentation model, a segmentation map based on the image data,
the segmentation map including a plurality of points and defining a training polygon boundary, the plurality of points being associated with a respective feature vector generated by the segmentation model,
the training polygon boundary identifying the training object in the training region, the training polygon boundary including a sequence of boundary points, a position of a given boundary point in the sequence being defined as a change in position from a position of a preceding boundary point in the sequence;
acquire a ground-truth polygon boundary identifying the training object on the segmentation map, the ground-truth polygon boundary including a sequence of boundary edges identified by a human assessor;
for the given boundary point in the sequence:
determine a displacement between the position and a closest edge from the sequence of edges, the displacement being indicative of a label for the given boundary point;
train a second model for predicting a confidence score for an in-use boundary point of an in-use polygon boundary, the training including, during a given training iteration:
use, by the second model, the position of the given boundary point, the feature vector associated with the boundary point, and a set of feature vectors of neighboring points on the segmentation map representative of a context of the given boundary point, for generating a predicted score;
adjust the second model based on a comparison between the predicted score and the label.

14. The processor of claim 13, wherein the processor is further configured to:
acquire in-use image data about an in-use region having an in-use object, the in-use object not having been assessed by the human assessor for generating a ground-truth polygon boundary identifying the in-use object;
generate, using the segmentation model, an in-use segmentation map defining the in-use polygon boundary, the in-use polygon boundary including a sequence of in-use boundary points; and
generate, using the second model, the confidence score for the in-use boundary point from the sequence of in-use boundary points; and
in response to the confidence score being indicative of a low confidence, automatically identify at least a portion of the in-use region for human assessment; and
acquire the ground-truth polygon boundary of the in-use object from the human assessor.

15. The processor of claim 13, wherein the training object is one of a road segment, and a sidewalk segment.

16. The processor of claim 13, wherein the image data comprises a birds-eye view representation of the training region.

17. The processor of claim 13, wherein the image data comprises a 2D image of the training region, the 2D image being generated from a 3D point cloud representative of the training region.

18. The processor of claim 13, wherein the image data comprises one or more raster images.

19. The processor of claim 13, wherein the segmentation model is a fully convolutional neural network.

20. The processor of claim 13, wherein the second model is a classification model, and wherein the label is indicative of a first class if the displacement is below a pre-determined threshold and is indicative of a second class if the displacement if above the pre-determined threshold, the first class being a high confidence class and the second class being a low confidence class.

21. The processor of claim 13, wherein the second model has two heads, a first head being trained based on a first label indicative of a given displacement to the closest edge, and a second head being trained on a second label indicative of whether the displacement is below or above a pre-determined threshold.

22. The processor of claim 13, wherein the in-use polygon boundary is stored in association with the in-use region, and wherein the in-use polygon boundary is transmitted to a second processor associated with a vehicle for navigating the vehicle in the in-use region.

23. The processor of claim 22, wherein the vehicle is a Self-Driving Car (SDC) operating on road segments.

24. The processor of claim 22, wherein the vehicle is a delivery robot operating on sidewalk segments.
